(19) United States
(12) Patent Application Publication
(10) Pub. No.: US 2024/0127260 A1
(43) Pub. Date: Apr. 18, 2024

(54) Method and System to Measure and Report Scope-2 Indirect Emissions Caused by Equipment Operating in a Datacenter

(71) Applicant: Dell Products L.P., Round Rock, TX (US)

(72) Inventors: Shivendra Katiyar, Bangalore (IN); Rishi Mukherjee, Bangalore (IN); Lori L. Matthews, Austin, TX (US)

(73) Assignee: Dell Products L.P., Round Rock, TX (US)

(21) Appl. No.: 17/965,319

(22) Filed: Oct. 13, 2022

(51) Int. Cl. G06Q 30/00; G06Q 10/06

(52) U.S. Cl. CPC G06Q 30/018; G06Q 10/06375; G06Q 10/06393

(57) ABSTRACT

Described herein are methods and a system for reading and reporting of energy consumption data of managed hardware, such as devices in a data center, and scope 2 GHG emissions attributable to the use of the devices. Emission factors are captured which are associated with energy sources that provide energy to the data center and the devices. Energy consumption of the devices are read. The consumed energy of the devices is converted to GHG emissions and reported.

### BACKGROUND OF THE INVENTION

### Field of the Invention

The present invention relates to energy measuring and reporting of devices implemented by information handling systems. More specifically, embodiments of the invention provide for measuring and reporting carbon emissions as a result of energy usage of devices in a data center.

### Description of the Related Art

The greenhouse gas (GHG) emissions protocol is a global standard used to measure and manage greenhouse gas (GHG) emissions from private and public sector operations. Such operations include datacenters that are managed by organizations or entities (i.e., customers) of devices operating in the datacenters. The GHG protocol addresses “scope 1” or direct emissions, that result from on-site energy uses, “scope 2” or indirect emissions from energy purchased from external sources, and “scope 3” or indirect emissions from energy (i.e., electricity) consumed by assets not owned or controlled by an entity, but indirectly impacts the value chain of the entity.

It is desirable for organizations/entities to determine and to try to improve (reduce) their GHG emissions. “Scope 1” emissions is expected to be easier to determine than “scope 2” and “scope 3” emissions, since “scope 1” emissions are controlled by the entity. “Scope 3” emissions may be impossible to determine, since the entity has no control of the assets that create such emissions. There should be a means to determine “scope 2” emissions by an organization, and adjust such “scope 2” emissions based on the energy that is purchased.

Providers of devices, such as server computers, used in data centers, should be able to help customers (i.e., entities) to determine and adjust GHG emissions attributed to use of the devices, since such devices can contribute to a great percentage of the energy consumed in the data centers. Determining the emissions from their data centers allows entities (i.e., customers of devices) to adjust for changes that could lower and improve their GHG emissions, and particularly “scope 2” emissions.

It is understood that depending on location, energy sources can vary greatly as to GHG emissions. For example, Norway has a great number of sustainable/renewable energy resources that provide relatively lower GHG emissions compared to a country like Chad which is dependent on fossil fuel sources that generate relatively higher GHG emissions. Regardless of location, entities can reduce their GHG emissions by monitoring and determining energy use of devices in data centers. Devices and hardware that are not power efficient can be replaced with more efficient devices to reduce GHG emissions. Therefore, it is desirable to provide for systems and methods to determine GHG emissions, and particularly “scope 2” emissions of data centers.

### SUMMARY OF THE INVENTION

A computer-implementable method, system and computer-readable storage medium for measuring and reporting scope 2 GHG emissions attributable to use of devices in a datacenter comprising capturing emission factors associated with energy sources providing energy to the devices of the data center; reading energy consumption of the devices of the data center; converting consumed energy of the devices of the data center to GHG emissions; and reporting the GHG emissions of the devices of the data center.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a general illustration of components of an information handling system as implemented in the present invention;

FIG. 2 illustrates a system as implemented in the present invention;

FIG. 3 is a generalized flowchart for measuring and reporting of scope 2 emissions attributable to use of devices in a datacenter;

FIG. 4 illustrates a configuration of energy consumption and attributable GHG emissions for a datacenter; and

FIG. 5 illustrates graphical information as to energy usage as to fuel type attributable to devices in a data center.

### DETAILED DESCRIPTION

Implementations described herein provide for reading and reporting of energy consumption data of managed hardware, such as devices in a data center. In certain implementations, a management power console is provided that reads and reports such energy consumption data. Emission factor information (i.e., GHG emissions) related to external power or energy sources as they relate to data centers and devices, and are converted to energy consumed as to GHG emissions. Such emission factors can either be provided by the data center administrator/operator in the case of a dark site, or can be read automatically from public resources. A dark site is defined as a site/location, such as the data center, which does not have access to external resource information, such as lack of connectivity to the Internet. Measured emissions can be reported based on a timeseries stream for comparison and other purposes related to tracking progress towards improved GHG emissions or sustainability goals.

Consideration is made as to a mix of energy sources in deriving attributable GHG emissions attributable to devices in the data center. Such implementations can lead to compliance as to carbon reforms, regulatory and governmental requirements. Furthermore, such implementations can help determine “how green” an entity (operator of data center) is, including comparison to other entities. The need to design for, procure, change operations of, and sustain energy consuming devices can also be achieved.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, gaming, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a microphone, keyboard, a video display, a mouse, etc. The information handling system may also include one or more buses operable to transmit communications between the various hardware components.

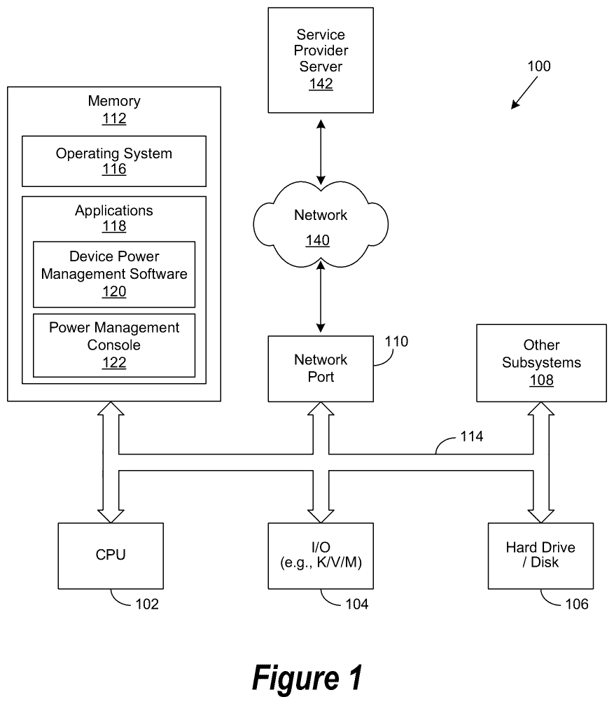

FIG. 1 is a generalized illustration of an information handling system (IHS) 100 that can be used to implement the system and method of the present invention. The information handing system (IHS) 100 can be a host to the peripheral devices described herein.

The information handling system (IHS) 100 includes a processor (e.g., central processor unit or “CPU”) 102, input/output (I/O) devices 104, such as a microphone, a keyboard, a video display or display device, a mouse, and associated controllers (e.g., K/V/M), a hard drive or disk storage 106, and various other subsystems 108.

In various embodiments, the information handling system (IHS) 100 also includes network port 110 operable to connect to a network 140, where network 140 can include one or more wired and wireless networks, including the Internet. Network 140 is likewise accessible by a service provider server 142.

The information handling system (IHS) 100 likewise includes system memory 112, which is interconnected to the foregoing via one or more buses 114. System memory 112 can be implemented as hardware, firmware, software, or a combination of such. System memory 112 further includes an operating system (OS) 116 and applications 118. Implementations provide for applications 118 to include power management software 120 that allows the information handling system 100 to access power consumption and other relevant information of devices, such as devices residing at data centers. In addition, the power management software 120 can be configured to receive emission factors from sources, such as public sources/websites or entered by a user. Implementations provide for a user interface, in the form of power management console 122 to interface power management software 120, allowing users to enter emission factor information, in particular when operating as a dark site or when the data center does not have access to sources/websites that provide emission factor information. The power management console 122 allows the ability to read and report energy consumption data of devices in a data center. The power management software 120 and power management console 122 are further described herein.

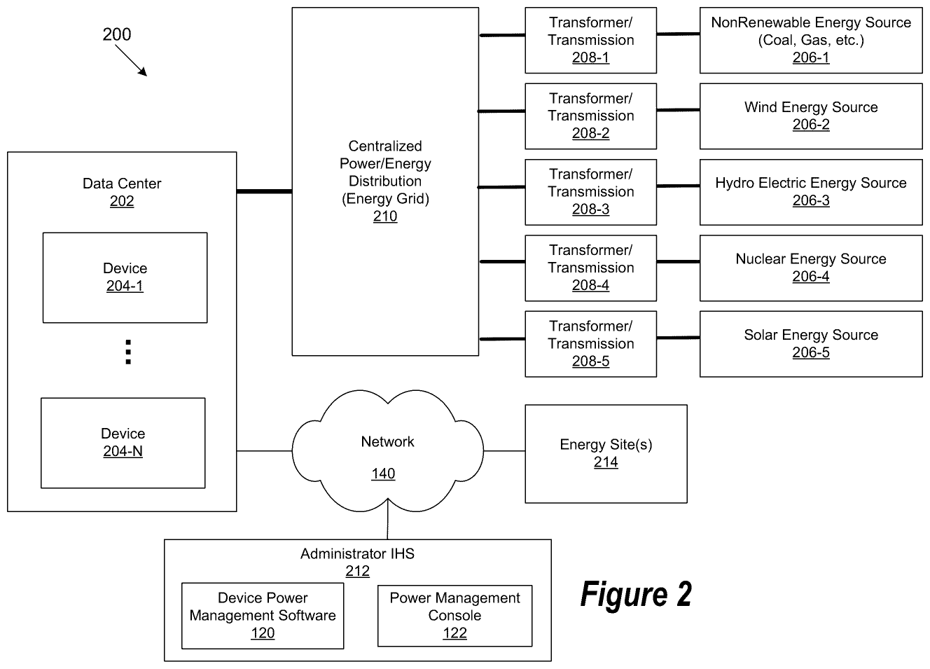

FIG. 2 shows a system 200 that supports the processes described herein. The system 200 includes and supports a data center 202. The data center may be controlled and operated by an entity, such as a customer operating equipment from a provider. The data center 202 includes multiple devices 204-1 to 204-N. The devices 204 can include equipment from the provider. Examples of devices 204 include computing devices, such as server computers, data storage devices, networking devices, power delivery devices (e.g., uninterrupted power supplies), etc. Various services and applications can run on devices 204. The devices 204 consume energy (i.e., electricity), where such energy consumption indirectly contributes to GHG emissions, and particularly scope 2 GHG emissions. As further described herein, energy consumption and attributable GHG emissions for the devices 204 and collectively for the data center 202 is performed. In particular, measuring and reporting of scope 2 GHG emissions is performed.

Various implementations provide for the system 200 to include one or more energy sources 206 that provide energy (i.e., electricity) to the data center 202 and devices 202. Examples of energy sources 206 include nonrenewable energy source (coal, gas, etc.) 206-1, wind energy source 206-2, hydro electric energy source 206-3, nuclear energy source 206-4, and solar energy source 206-5.

The energy sources 206 provide energy (i.e., electricity) to data center 202 and devices 204, via transformer(s)/transmission line(s) 208. In various implementations, the transformer(s)/transmission line(s) 208 provide the energy (i.e., electricity) to a centralized power/energy distribution center or energy grid 210. The centralized power/energy distribution center or energy grid 210 provides the energy (i.e., electricity) to the data center 202 and devices 204. In various implementations, the energy grid 210 determines contribution of energy (i.e., electricity) that is received from the energy sources 206 and delivered to the data center 202.

In various implementations a mix of energy sources 206 provide energy (i.e., electricity) to the data center 202 and devices 204. Each of the energy sources 206 has associated GHG emissions or GHG emissions factors (emission factor). The mix of energy sources 206 can be static or dynamic, changing throughout the day, quarter or a specific period.

An emission factor can be considered as a coefficient that describes the rate at which a given activity releases greenhouse gases (GHGs) into the atmosphere. In the industry, emission factors are also referred to as conversion factors, emission intensity and carbon intensity.

The use of emission factors is commonly known in the industry. CO₂e emissions includes carbon monoxide and as well as other gases, such as methane, nitrous oxide, etc. For example, in order to convert an activity into CO2e emissions, the activity is provided in some activity unit. An emission factor is used as an intermediary between the activity unit, converting the activity unit to CO2e, typically expressed in kg or tons.

Implementations provide for the system 200 to include an administrator information handling system (IHS) 212, that can be configured as an information handling system (IHS) 100 as described in FIG. 1. Administrator IHS 212 is configured to perform processes and methods described herein, and can include device power management software 120 and power management console 122. Implementations provide for the administrator IHS 212 to connect with network 140 as described above, and communicate with data center 202 and devices 204. In particular, administrator IHS 212 through device power management software 120 and power management console 122 monitors and reports energy (i.e., electricity) usage of the data center 202 and specifically the devices 204, as described herein.

Implementations further provide for the administrator IHS 212 through network 140 to access (e.g., via Internet) various resources and databases, such as energy site(s) 214 which provide emission data/factors related to energy sources 206. In particular, the power management console 122 can be configured to access and receive emission data/factors (emission factors) from the resources and databases, such as energy site(s) 214.

The energy site(s) 214 can include readily available public sites. Examples of links include https://electricitymap.org/ and https://singularity.energy/. Such energy site(s) 214 can provide updated and forecasted emission data/factors (emission factors) which are read or downloaded periodically by the administrator IHS 212. The updated emission factors provide visibility into changes and allow for more accurate calculations as described herein.

In cases where the data center 202 is considered as a dark site without access to the Internet and to resources and databases, such as energy site(s) 214 which provide emission factors, emissions factors as to energy sources 206 can be entered through the power management console 122. An owner/administrator of data center 202 may desire to use emission factors that they are aware of, instead of receiving of receiving emission factors from resources and databases, such as energy site(s) 214. In such instances, an override capability can be provided through the power management console 122. Therefore, there can be considered two options to create emission factor entries for energy sources 206. For “built in emission factors”, the emission factors are received from resources and databases, such as energy site(s) 214. For “custom emission factors”, the emission factors desired values are provided by owner/administrator of data center 202.

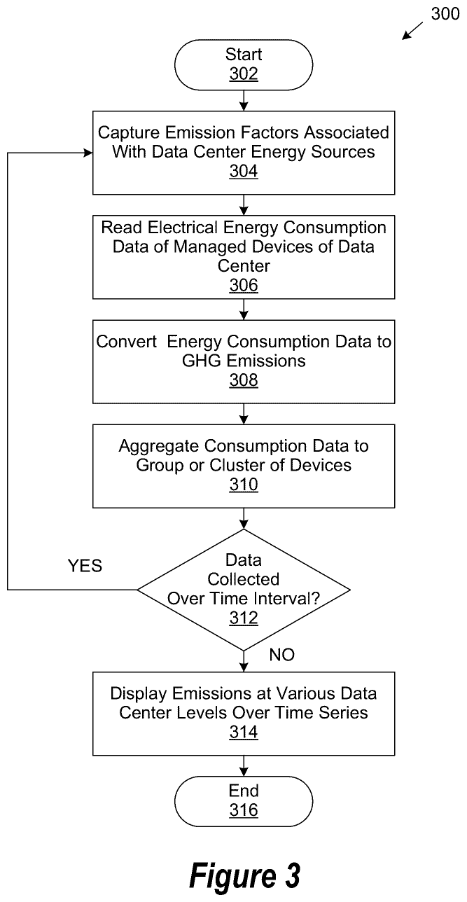

FIG. 3 shows a generalized flowchart for measuring and reporting of scope 2 GHG emissions attributable to use of devices in a datacenter. Implementations provide for the steps of process 300 to be performed by the power management software 120 and power management console 122. The order in which the method is described is not intended to be construed as a limitation, and any number of the described method steps may be combined in any order to implement the method, or alternate method.

Additionally, individual steps may be deleted from the method without departing from the spirit and scope of the subject matter described herein. Furthermore, the method may be implemented in any suitable hardware, software, firmware, or a combination thereof, without departing from the scope of the invention.

At step 302, the process 300 starts. At step 304, emission factors associated with the data center 202 and devices 204 are captured. Such emissions factors are related to the energy sources 206 providing energy (i.e., electricity) to the data center 202 and devices 204. As discussed, the captured emission factors are coefficients which allows conversion of activity data into GHS emission associated the energy sources 206. As discussed, emission factors can be captured or read from resources and databases, such as energy site(s) 214 or “built in emission factors” option, or in the case of a dark site or a desire to override, emission factors are configured by an owner/administrator or “custom emission factors”.

At step 306, energy (i.e., electricity) consumption is read of devices 204 of the data center 202. As discussed, any managed device 204 that consumes energy (i.e., electricity) can be read by administrator IHS 212 through power management console 122. Devices 204 include computing devices, data storage devices, networking devices, power delivery devices, etc.

At step 308, consumed energy of the devices is converted to GHG emissions. The following Equation 1 can be used.

Eg=EC*EFg Equation 1

The value “g” represents a particular greenhouse gas, such as CO₂ (Carbon Dioxide) CH₄ (methane), N₂O (nitrous dioxide), or CO₂e (carbon monoxide and other gases). The value “E” represents GHG emission in “kgCO2e” unit. The value “EF” is an emission factor.” The value “EC” is energy consumed.

At step 310, the energy consumption data can be aggregated for a group or cluster of devices 204 of the data center 202. The following Equation 2 can be used for aggregating energy consumption data.

$${AEF}_{ℊ} = \frac{( {\sum }_{1}^{n} ( {EF}_{ℊ} \times PEP ) )}{100} \qquad Equation 2$$

The value “g” represents a particular greenhouse gas, such as CO₂ (Carbon Dioxide) CH₄ (methane), N₂O (nitrous dioxide), or CO₂e (carbon monoxide and other gases). The value “n” represents the number of device 204 entries. The value “AEF” represents aggregate emission factor. The value “EF” is an emission factor”. The value “PEP” represents a percentage of the energy source 204 that contributes to total energy provided to the data center 202 and devices 204, as discussed above.

In various implementations, the preceding steps are performed periodically, and data is collected over a timer period. If so, following the “YES” branch of step 312, step 304 is performed. Otherwise, if no additional data is to be collected, following the “NO” branch of step 312, step 314 is performed. At step 314, GHG emissions attributed to energy (i.e., electricity) is provided/displayed, which can be provided/displayed at using the power management console 122. This can be performed at various data center levels and/or over a time series. At step 316, the process 600 ends.

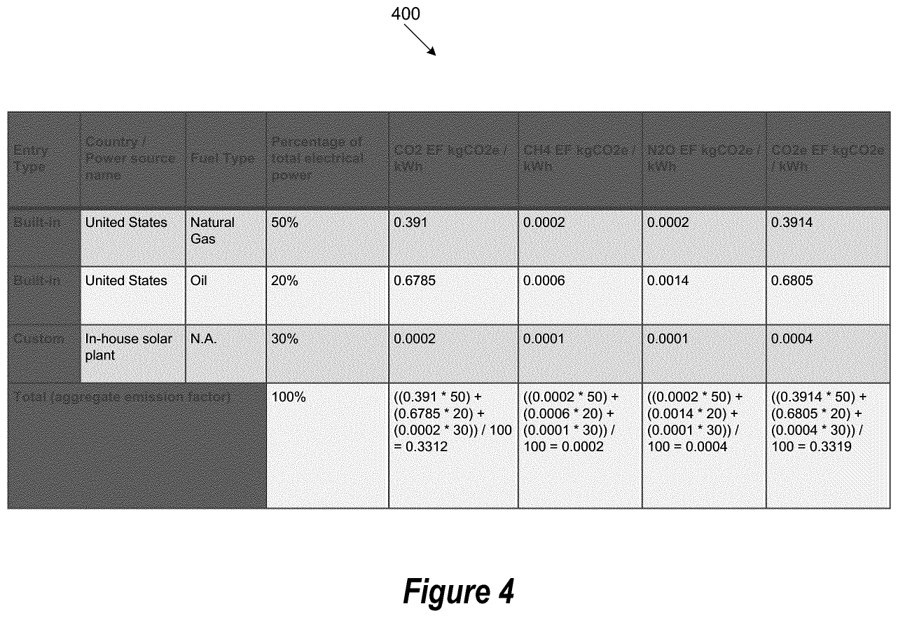

FIG. 4 shows an example of a configuration of energy consumption and attributable GHG emissions for a datacenter 202. The entry type is identified. Country or power source (energy source 206) is identified. Fuel type is identified. The particular greenhouse gases are identified. The respective columns are provided values. A total or aggregate emission factor value is summed for the columns.

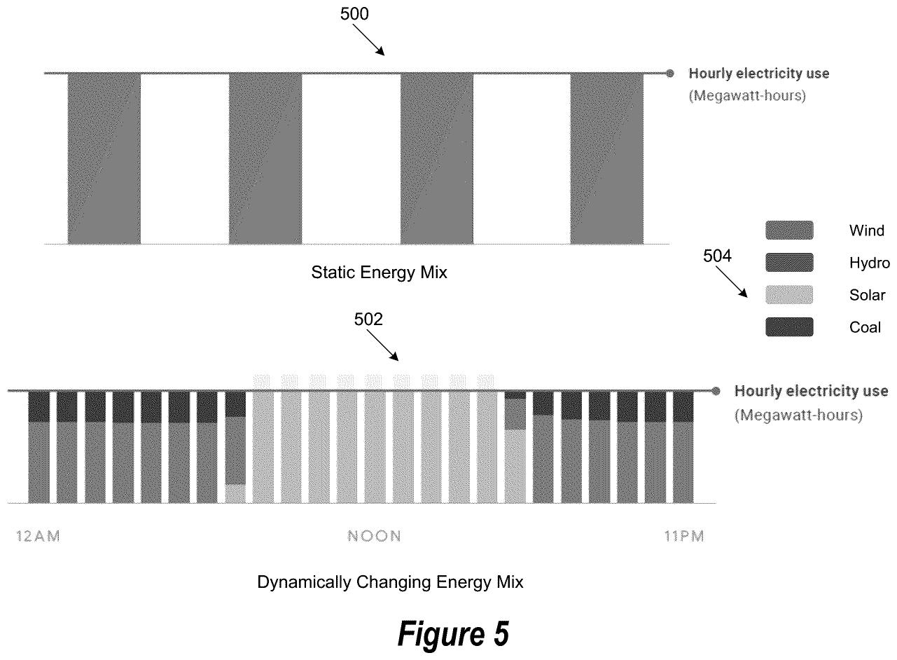

FIG. 5 shows graphical information as to energy usage as to fuel type attributable to devices in a data center 202. Implementations provide for such graphical information to be presented/provided at the power management console 122. Graphical information 500 represents hourly electricity consumption of a static energy mix. Graphical information 502 represents hourly electricity consumption of a dynamic energy mix. 504 represents the legend of particular fuel type.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only and are not exhaustive of the scope of the invention.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object-oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchart illustrations and/or step diagrams of methods, apparatus (systems) and computer program products according to embodiments of the invention. It will be understood that each step of the flowchart illustrations and/or step diagrams, and combinations of steps in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram step or steps.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only and are not exhaustive of the scope of the invention.

Consequently, the invention is intended to be limited only by the spirit and scope of the appended claims, giving full cognizance to equivalents in all respects.

What is claimed is:

1. A computer-implementable method for measuring and reporting scope 2 GHG emissions attributable to use of devices in a datacenter comprising:
capturing emission factors associated with energy sources providing energy to the devices of the data center;
reading energy consumption of the devices of the data center;
converting consumed energy of the devices of the data center to GHG emissions; and
reporting the GHG emissions of the devices of the data center.

2. The computer-implementable method of claim 1, wherein the capturing is performed by reading the emissions factors from external resources, databases, or energy sites.

3. The computer-implementable method of claim 1, wherein the capturing is performed by using customized emission factors.

4. The computer-implementable method of claim 1, wherein the converting is performed by the equation Eg=EC*EFg, wherein g represents a particular greenhouse gas, E represents GHG emission, EF represents emission factor, and EC is energy consumed.

5. The computer-implementable method of claim 1 further comprising aggregating the energy consumption of the devices of the data center.

6. The computer-implementable method of claim 5, wherein the aggregating is performed by the equation
$${AEF}_{ℊ} = \frac{( {\sum }_{1}^{n} ( {EF}_{ℊ} \times PEP ) )}{100} ,$$
wherein g represents a particular greenhouse gas, n represents a number of device entries, AEF represents aggregate emission factor, EF is an emission factor, and PEP represents a percentage an energy source contributes to total energy provided to the data center and devices.

7. The computer-implementable method of claim 1, wherein the steps are performed periodically, and the reporting is performed over a timeseries.

8. A system comprising:
a plurality of processing systems communicably coupled through a network, wherein the processing systems include non-transitory, computer-readable storage medium embodying computer program code interacting with a plurality of computer operations measuring and reporting scope 2 GHG emissions attributable to use of devices in a datacenter comprising:
capturing emission factors associated with energy sources providing energy to the devices of the data center;
reading energy consumption of the devices of the data center;
converting consumed energy of the devices of the data center to GHG emissions; and
reporting the GHG emissions of the devices of the data center.

9. The system of claim 8, wherein the capturing is performed by reading the emissions factors from external resources, databases, or energy sites.

10. The system of claim 8, wherein the capturing is performed by using customized emission factors.

11. The system of claim 8, wherein the converting is performed by the equation Eg=EC*EFg, wherein g represents a particular greenhouse gas, E represents GHG emission, EF represents emission factor, and EC is energy consumed.

12. The system of claim 8 further comprising aggregating the energy consumption of the devices of the data center.

13. The system of claim 12, wherein the aggregating is performed by the equation
$${AEF}_{ℊ} = \frac{( {\sum }_{1}^{n} ( {EF}_{ℊ} \times PEP ) )}{100} ,$$
wherein g represents a particular greenhouse gas, n represents a number of device entries, AEF represents aggregate emission factor, EF is an emission factor, and PEP represents a percentage an energy source contributes to total energy provided to the data center and devices.

14. The system of claim 8, wherein the steps are performed periodically, and the reporting is performed over a timeseries.

15. A non-transitory, computer-readable storage medium embodying computer program code for measuring and reporting scope 2 GHG emissions attributable to use of devices in a datacenter, the computer program code comprising computer executable instructions configured for:
capturing emission factors associated with energy sources providing energy to the devices of the data center;
reading energy consumption of the devices of the data center;
converting consumed energy of the devices of the data center to GHG emissions; and
reporting the GHG emissions of the devices of the data center.

16. The non-transitory, computer-readable storage medium of claim 15, wherein the capturing is performed by reading the emissions factors from external resources, databases, or energy sites.

17. The non-transitory, computer-readable storage medium of claim 15, wherein the capturing is performed by using customized emission factors.

18. The non-transitory, computer-readable storage medium of claim 15, wherein the converting is performed by the equation Eg=EC*EFg, wherein g represents a particular greenhouse gas, E represents GHG emission, EF represents emission factor, and EC is energy consumed.

19. The non-transitory, computer-readable storage medium of claim 15 further comprising aggregating the energy consumption of the devices of the data center.

20. The non-transitory, computer-readable storage medium of claim 15 wherein the steps are performed periodically, and the reporting is performed over a timeseries.
